(19) United States
(12) Patent Application Publication
(10) Pub. No.: US 2026/0112296 A1
(43) Pub. Date: Apr. 23, 2026

(54) MATERIAL DISPLAY ASSEMBLY

(71) Applicant: Batesville Services, LLC, Batesville, IN (US)

(72) Inventor: Gregory William Wray, Guilford, IN (US)

(73) Assignee: Batesville Services, LLC, Batesville, IN (US)

(21) Appl. No.: 19/320,581

(22) Filed: Sep. 5, 2025

Related U.S. Application Data
(60) Provisional application No. 63/708,455, filed on Oct. 17, 2024.

(51) Int. Cl. G09F 3/18

(52) U.S. Cl. CPC G09F 3/185

(57) ABSTRACT

A material display assembly includes a back panel, an intermediate panel, an intermediate cutout formed in the intermediate panel intersecting an edge of the intermediate panel and defining an intermediate cutout region, the intermediate panel defining a material backing region adjacent the intermediate cutout region, a front panel, a front cutout formed in the front panel and defining a front cutout region overlapping the material backing region of the intermediate panel, the front panel defining a display region adjacent the front cutout and overlapping the intermediate cutout region, the display region being transparent, and one or more fasteners securing the intermediate panel to the back panel and the front panel.

### CROSS-REFERENCE TO RELATED APPLICATION

This application claims the benefit of co-pending U.S. Provisional Ser. No. 63/708,455 , filed Oct. 17, 2024, for “Material Display Assembly,” which is hereby incorporated by reference in its entirety including the drawings.

### TECHNICAL FIELD

The present specification generally relates to assemblies for displaying materials and, more specifically, assemblies for permitting materials and display information to be readily changed.

### BACKGROUND

In certain environments, it is useful to a potential purchaser to view product information, for example, price, sizing, etc., when viewing a product. Additionally, it is desirable for the seller to be able to readily change the information being displayed based on changes in price, availability, and the like. However, current displays that provide such product information may not accommodate product samples. Oftentimes, current displays do not provide a means for easily changing the product information being displayed without excessive manipulation and disassembly of the display itself.

Accordingly, a need exists for improved display assemblies that allow for a person to readily change the information and material samples being displayed to a potential purchaser.

### SUMMARY

In one embodiment, a material display assembly includes a back panel, an intermediate panel, an intermediate cutout formed in the intermediate panel intersecting an edge of the intermediate panel and defining an intermediate cutout region, the intermediate panel defining a material backing region adjacent the intermediate cutout region, a front panel, a front cutout formed in the front panel and defining a front cutout region overlapping the material backing region of the intermediate panel, the front panel defining a display region adjacent the front cutout and overlapping the intermediate cutout region, the display region being transparent, and one or more fasteners securing the intermediate panel to the back panel and the front panel.

In another embodiment, a material display assembly includes a back panel, a front panel, a pair of front cutouts formed in the front panel and spaced apart from one another and defining a front cutout region, the front panel defining a display region adjacent the front cutout region, the display region being transparent, and one or more fasteners securing the back panel to the front panel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an exploded perspective view of an embodiment of a material display assembly, according to one or more embodiments shown and described herein;

FIG. 2 schematically displays a front view of the material display assembly of FIG. 1, according to one or more embodiments shown and described herein;

FIG. 3 schematically depicts an exploded perspective view of another embodiment of a material display assembly, according to one or more embodiments shown and described herein;

FIG. 4 schematically depicts an exploded perspective view of another embodiment of a material display assembly, according to one or more embodiments shown and described herein;

FIG. 5 schematically displays a side end view of the material display assembly of FIG. 1, according to one or more embodiments shown and described herein;

FIG. 6A schematically displays a perspective view of a screw post of the material display assembly of FIG. 1, according to one or more embodiments shown and described herein;

FIG. 6B schematically displays a side view of the screw post of the material display assembly of FIG. 1, according to one or more embodiments shown and described herein;

FIG. 7A schematically displays a perspective view of a washer of the material display assembly of FIG. 1, according to one or more embodiments shown and described herein;

FIG. 7B schematically displays a side view of the washer of the material display assembly of FIG. 1, according to one or more embodiments shown and described herein;

FIG. 8A schematically displays a perspective view of a screw of the material display assembly of FIG. 1, according to one or more embodiments shown and described herein; and

FIG. 8B schematically displays a side view of the screw of the material display assembly of FIG. 1, according to one or more embodiments shown and described herein.

### DETAILED DESCRIPTION

Embodiments described herein are directed to a material display assembly that includes at least a back panel and a front panel having one or more front cutouts in which a material sample may be displayed. A display sheet including product information relevant to the material samples may be positioned between the back panel and the front panel. Various embodiments of the material display assembly and use of the material display assembly are described in more detail herein. Whenever possible, the same reference numerals will be used throughout the drawings to refer to the same or like parts.

When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

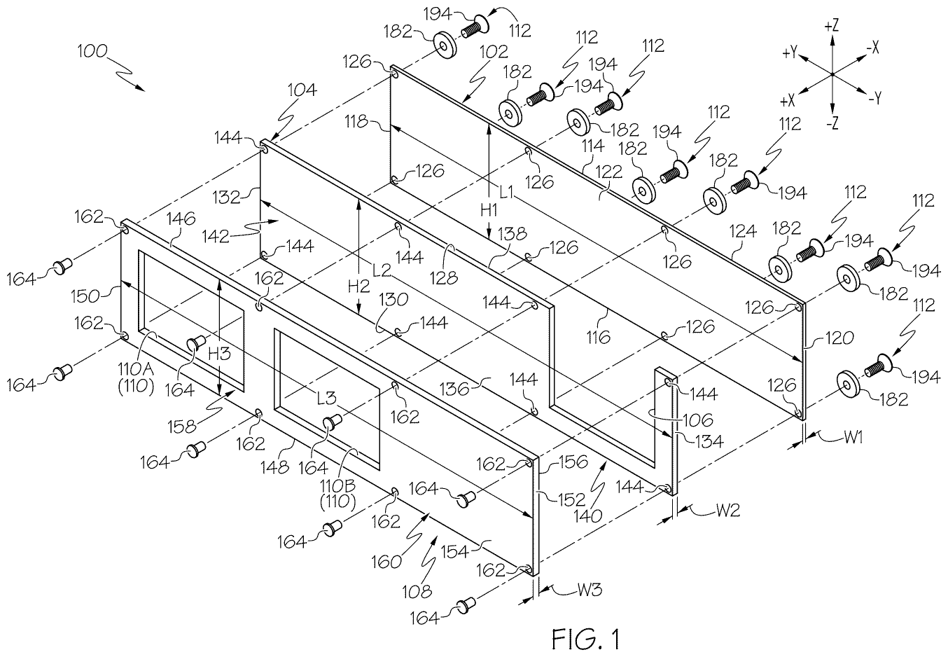

As used herein, the term “longitudinal direction” refers to the forward-rearward direction (i.e., in the +/−Y direction of the coordinate axes depicted in FIG. 1). The term “lateral direction” refers to the cross direction (i.e., in the +/−X direction of the coordinate axes depicted in FIG. 1), and is transverse to the longitudinal direction. The term “vertical direction” refers to the upward-downward direction (i.e., in the +/−Z direction of the coordinate axes depicted in FIG. 1).

Directional terms as used herein-for example up, down, right, left, front, back, top, bottom-are made only with reference to the figures as drawn and are not intended to imply absolute orientation. As used herein, “upper” and “above” are defined as the positive Z direction of the coordinate axes shown in the drawings. “Lower” and “below” are defined as the negative Z direction of the coordinate axes shown in the drawings.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring now to FIG. 1, an exploded view of a material display assembly 100 is illustrated according to one or more embodiments described herein. The material display assembly 100 may generally include a back panel 102, an intermediate panel 104 having an intermediate cutout 106 formed therein, a front panel 108 having a front cutout 110 formed therein and offset from the intermediate cutout 106 of the intermediate panel 104, and one or more fasteners 112 securing the intermediate panel 104 to the back panel 102 and the front panel 108.

The back panel 102 includes an upper edge 114, a lower edge 116 opposite the upper edge 114, a first side edge 118 extending between the upper edge 114 and the lower edge 116, and a second side edge 120 opposite the first side edge 118 extending between the upper edge 114 and the lower edge 116. The back panel 102 also includes a front surface 122 and a rear surface 124 opposite the front surface 122.

As shown in FIG. 1, the back panel 102 has a generally rectangular shape defined by the upper edge 114, the lower edge 116, the first side edge 118, and the second side edge 120. Accordingly, the back panel 102 has a height H1 defined by a height of the first side edge 118 and the second side edge 120 extending in the vertical direction, a length L1 defined by a length of the upper edge 114 and the lower edge 116 extending in the longitudinal direction, and a width W1 defined by a thickness of the first side edge 118 and the second side edge 120 extending in the lateral direction.

In embodiments, the width W1 of the back panel 102 is greater than or equal to 0.5 mm and less than or equal to 5 mm. In embodiments, the width W1 of the back panel 102 is greater than or equal to 1 mm and less than or equal to 3 mm. In embodiments, the width W1 of the back panel 102 is greater than or equal to 1.5 mm and less than or equal to 2.5 mm. In embodiments, the width W1 of the back panel 102 is 1 mm+/−20%. In embodiments, the width W1 of the back panel 102 is 1 mm+/−15%. In embodiments, the width W1 of the back panel 102 is 1 mm+/−10%. In embodiments, the width W1 of the back panel 102 is 1 mm+/−5%. However, in other embodiments, it should be appreciated that the back panel 102 may have any suitable shape, for example, square, circular, triangular, or the like.

The back panel 102 may be formed from any suitable material, for example, acrylic, plywood, particleboard, polyvinyl chloride (PVC), and the like. Accordingly, contrary to the front panel 108 discussed herein, the back panel 102 may be formed from a non-transparent material.

In embodiments, one or more holes 126 are formed in the back panel 102. As shown in FIG. 1, a plurality of holes 126 are formed in the back panel 102. The holes 126 are spaced apart from one another along the upper edge 114 and the lower edge 116 of the back panel 102. Although FIG. 1 illustrates eight holes 126 being formed in the back panel 102, it should be appreciated that any number of holes 126 may be provided and formed at any suitable location of the back panel 102. As described in more detail herein, a fastener 112 extends through each of the holes 126 to secure the back panel 102 to the intermediate panel 104 and the front panel 108. In other embodiments, as described in more detail herein, it should be appreciated that the holes 126 may not be formed in the back panel 102, and the back panel 102 may be removably attached to the intermediate panel 104 and the front panel 108 in any other suitable manner, for example, clasps, magnets, and the like.

Referring still to FIG. 1, the intermediate panel 104 is now described with more particularity. The intermediate panel 104 includes an upper edge 128, a lower edge 130 opposite the upper edge 128, a first side edge 132 extending between the upper edge 128 and the lower edge 130, and a second side edge 134 opposite the first side edge 132 extending between the upper edge 128 and the lower edge 130. The intermediate panel 104 also includes a front surface 136 and a rear surface 138 opposite the front surface 136.

As shown in FIG. 1, the intermediate panel 104 has a generally rectangular shape defined by the upper edge 128, the lower edge 130, the first side edge 132, and the second side edge 134. Accordingly, the intermediate panel 104 has a height H2 defined by a height of the first side edge 132 and the second side edge 134 extending in the vertical direction, a length defined by a length of the upper edge 128 and the lower edge 130 extending in the longitudinal direction, and a width W2 defined by a thickness of the first side edge 132 and the second side edge 134 extending in the lateral direction.

In embodiments, the width W2 of the intermediate panel 104 is greater than or equal to 0.5 mm and less than or equal to 5 mm. In embodiments, the width W2 of the intermediate panel 104 is greater than or equal to 1 mm and less than or equal to 3 mm. In embodiments, the width W2 of the intermediate panel 104 is greater than or equal to 1.5 mm and less than or equal to 2.5 mm. In embodiments, the width W2 of the intermediate panel 104 is 1 mm+/−20%. In embodiments, the width W2 of the intermediate panel 104 is 1 mm+/−15%. In embodiments, the width W2 of the intermediate panel 104 is 1 mm+/−10%. In embodiments, the width of the intermediate panel is 1 mm+/−5%. However, in other embodiments, it should be appreciated that the intermediate panel 104 may have any suitable shape, for example, square, circular, triangular, or the like. In embodiments, the width W2 of the intermediate panel 104 is equal to the width W1 of the back panel 102. In embodiments, the width W2 of the intermediate panel 104 is greater than the width W1 of the back panel 102. In embodiments, the width W2 of the intermediate panel 104 is less than the width W1 of the back panel 102.

The intermediate cutout 106 is formed in the intermediate panel 104. Although only a single intermediate cutout 106 is shown formed in the intermediate panel 104, it should be appreciated that more than one intermediate cutout 106 may be formed. As shown in FIG. 1, the intermediate cutout 106 is a U-shaped cutout intersecting the upper edge 128 of the intermediate panel 104. Additionally, as shown, the intermediate cutout 106 is located proximate the second side edge 134 of the intermediate panel 104, i.e., closer to the second side edge 134 than to the first side edge 132. The intermediate cutout 106 may be formed by laser cutting or any other suitable method. The intermediate panel 104 defines an intermediate cutout region 140 in which the intermediate cutout 106 is formed, and a material backing region 142 located adjacent the intermediate cutout region 140 and extending along the length L2 of the intermediate panel 104.

The intermediate panel 104 may be formed from any suitable material, for example, acrylic, plywood, particleboard, PVC, and the like. Accordingly, contrary to the front panel 108 discussed herein, the intermediate panel 104 may be formed from a non-transparent material.

In embodiments, one or more holes 144 are formed in the intermediate panel 104. As shown in FIG. 1, a plurality of holes 144 are formed in the intermediate panel 104. The holes 144 are spaced apart from one another along the upper edge 128 and the lower edge 130 of the intermediate panel 104. Although FIG. 1 illustrates eight holes 144 being formed in the intermediate panel 104, it should be appreciated that any number of holes 144 may be provided and formed at any suitable location of the intermediate panel 104. The holes 144 formed in the intermediate panel 104 are coaxial with the holes 126 formed in the back panel 102. Accordingly, as described in more detail herein, the fastener 112 extends through each of the holes 144 to secure the intermediate panel 104 to the back panel 102 and the front panel 108. In other embodiments, as described in more detail herein, it should be appreciated that the holes 144 may not be formed in the intermediate panel 104, and the intermediate panel 104 may be removably attached to the back panel 102 and the front panel 108 in any other suitable manner, for example, clasps, magnets, and the like.

Referring still to FIG. 1, the front panel 108 is now described with more particularity. The front panel 108 includes an upper edge 146, a lower edge 148 opposite the upper edge 146, a first side edge 150 extending between the upper edge 146 and the lower edge 148, and a second side edge 152 opposite the first side edge 150 extending between the upper edge 146 and the lower edge 148. The front panel 108 also includes a front surface 154 and a rear surface 156 opposite the front surface 154.

As shown in FIG. 1, the front panel 108 has a generally rectangular shape defined by the upper edge 146, the lower edge 148, the first side edge 150, and the second side edge 152. Accordingly, the front panel 108 has a height H3 defined by a height of the first side edge 150 and the second side edge 152 extending in the vertical direction, a length L3 defined by a length of the upper edge 146 and the lower edge 148 extending in the longitudinal direction, and a width W3 defined by a thickness of the first side edge 150 and the second side edge 152 extending in the lateral direction.

In embodiments, the height H3 of the front panel 108 is equal to each of the height H1 of the back panel 102 and the height H2 of the intermediate panel 104. In embodiments, the height H3 of the front panel 108 is greater than each of the height H1 of the back panel 102 and the height H2 of the intermediate panel 104. In embodiments, the height H3 of the front panel 108 is less than each of the height H1 of the back panel 102 and the height H2 of the intermediate panel 104.

In embodiments, the length L3 of the front panel 108 is equal to each of the length L1 of the back panel 102 and the width L2 of the intermediate panel 104. In embodiments, the length L3 of the front panel 108 is greater than each of the length L1 of the back panel 102 and the length L2 of the intermediate panel 104. In embodiments, the length L3 of the front panel 108 is less than each of the length L1 of the back panel 102 and the length L2 of the intermediate panel 104.

In embodiments, the width W3 of the front panel 108 is equal to each of the width W1 of the back panel 102 and the width W2 of the intermediate panel 104. In embodiments, the width W3 of the front panel 108 is greater than each of the width W1 of the back panel 102 and the width W2 of the intermediate panel 104. In embodiments, the width W3 of the front panel 108 is less than each of the width W1 of the back panel 102 and the width W2 of the intermediate panel 104.

In embodiments, the width W3 of the front panel 108 is greater than or equal to 0.5 mm and less than or equal to 5 mm. In embodiments, the width W3 of the front panel 108 is greater than or equal to 1 mm and less than or equal to 3 mm. In embodiments, the width W3 of the front panel 108 is greater than or equal to 1.5 mm and less than or equal to 2.5 mm. In embodiments, the width W3 of the front panel 108 is 1 mm+/−20%. In embodiments, the width W3 of the front panel 108 is 1 mm+/−15%. In embodiments, the width W3 of the front panel 108 is 1 mm+/−10%. In embodiments, the width W3 of the front panel 108 is 1 mm+/−5%. However, in other embodiments, it should be appreciated that the front panel 108 may have any suitable shape, for example, square, circular, triangular, or the like.

One or more front cutouts 110 are formed in the front panel 108. As shown in FIG. 1, a pair of front cutouts 110 are formed in the front panel 108. Each of the front cutouts 110 is a U-shaped cutout intersecting the upper edge 146 of the front panel 108. The front cutouts 110 are spaced apart from one another and arranged along the length L3 of the front panel 108 in the longitudinal direction. Accordingly, as shown, a first front cutout 110A of the pair of front cutouts 110 is located proximate the first side edge 150 of the front panel 108, i.e., closer to the first side edge 150 than to the second side edge 152. Additionally, a second front cutout 110B of the pair of front cutouts 110 is located equidistantly between the first side edge 150 and the second side edge 152 of the front panel 108. The front cutouts 110 may be formed by laser cutting or any other suitable method. The front panel 108 defines a front cutout region 158 in which the front cutouts 110 are formed, and a display region 160 located adjacent the front cutout region 158 and extending along the length L3 of the front panel 108. As shown, the front cutouts 110 formed in the front cutout region 158 of the front panel 108 overlap the material backing region 142 of the intermediate panel 104. Additionally, the display region 160 of the front panel 108 overlaps the intermediate cutout region 140 of the intermediate panel 104. As such, the front cutouts 110 are offset from the intermediate cutout 106.

The front panel 108 may be formed from any suitable material, for example, acrylic, plywood, particleboard, PVC, and the like. In embodiments, at least the display region 160 of the front panel 108 is formed from a transparent material. In embodiments, the display region 160 is formed from a transparent material while the front cutout region 158 is formed from a non-transparent material. In other embodiments, the entire front panel 108 is formed from a transparent material. As used herein, the term “transparent” refers to a material or object that allows the passage of light with minimal obstruction, such that objects on the other side can be seen clearly without significant distortion or loss of detail.

This definition is relevant in contexts such as optics, materials science, and product design, where the transparency of a component is critical to its function or utility. Depending on the application, the transparency may be quantified in terms of the percentage of light transmitted or the degree of optical clarity.

In embodiments, one or more holes 162 are formed in the front panel 108. As shown in FIG. 1, a plurality of holes 162 are formed in the front panel 108. The holes 162 are spaced apart from one another along the upper edge 146 and the lower edge 148 of the front panel 108. Although FIG. 1 illustrates eight holes 162 being formed in the front panel 108, it should be appreciated that any number of holes 162 may be provided and formed at any suitable location of the front panel 108. The holes 162 formed in the front panel 108 are coaxial with the holes 126 formed in the back panel 102 and the holes 144 formed in the intermediate panel 104. Accordingly, as described in more detail herein, the fastener 112 extends through each of the holes 126, 144, 162 to secure the front panel 108 to the back panel 102 and the intermediate panel 104. In other embodiments, as described in more detail herein, it should be appreciated that the holes 162 may not be formed in the front panel 108, and the front panel 108 may be removably attached to the back panel 102 and the intermediate panel 104 in any other suitable manner, for example, clasps, magnets, and the like.

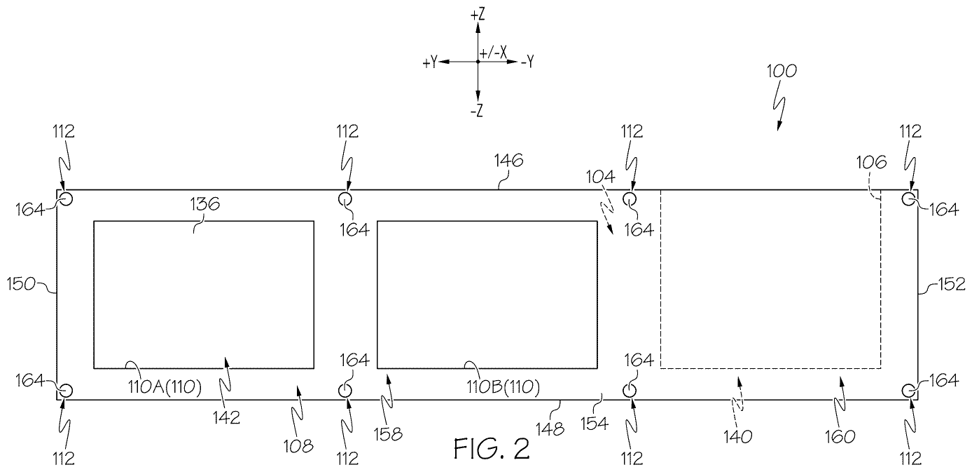

Referring now to FIG. 2, a front assembled view of the material display assembly 100 is shown with the fasteners 112 securing the back panel 102 (FIG. 1), the intermediate panel 104, and the front panel 108 to one another. As shown, the intermediate cutout 106 formed in the intermediate cutout region 140 of the intermediate panel 104 is offset from the front cutouts 110 formed in the front cutout region 158 of the front panel 108. More specifically, the front cutouts 110 are aligned with the intermediate cutout 106 in the longitudinal direction.

With the material display assembly 100 in the assembled state, the intermediate cutout 106 is open at the upper edge 128 (FIG. 1) of the intermediate panel 104 is formed between the back panel 102 and the front panel 108. Accordingly, a display sheet such as, for example, an information card or the like, may be inserted into the intermediate cutout 106 and viewed through the display region 160 of the front panel 108 formed of a transparent material. Additionally, material samples such as, for example, material swatches or the like, may be inserted into the front cutouts 110. The material samples may be secured to the intermediate panel 104 within the front cutouts 110 in any suitable manner, for example, by double-sided adhesive provided on a rear surface of the material samples and the intermediate panel 104. Accordingly, when a display sheet is inserted in the intermediate cutout 106 next to the material samples within the front cutouts 110, a viewer may be able to ascertain information of the material samples by reading text on the display sheet. Additionally, the display sheet and the material samples may be readily changed as desired.

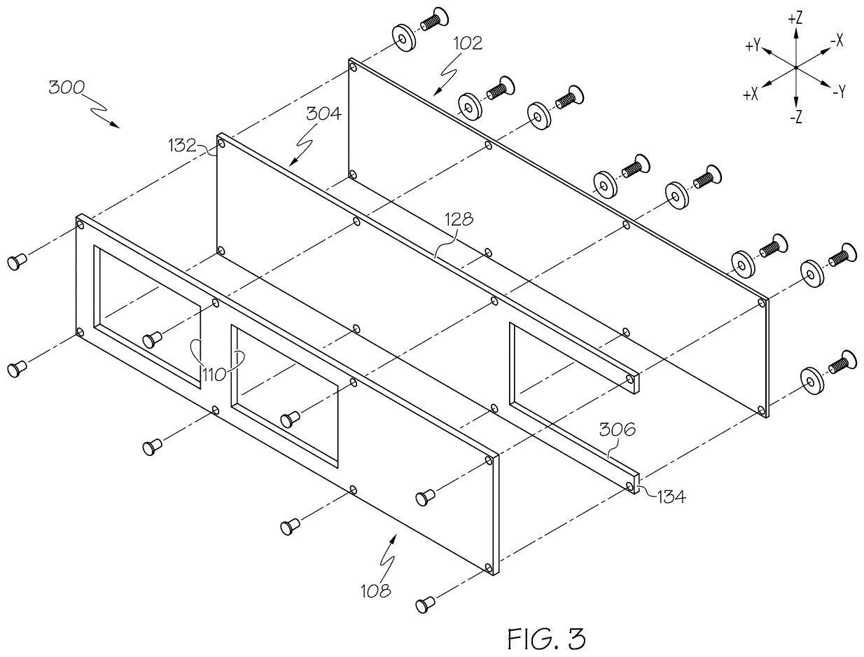

In other embodiments, as shown in FIG. 3, a material display assembly 300 is illustrated. It should be appreciated the material display assembly 300 is similar to the material display assembly 100 illustrated in FIG. 1. Therefore, like reference numbers will be used to refer to like parts. The material display assembly 300 includes the back panel 102, an intermediate panel 304, and the front panel 108. Contrary to the intermediate panel 104 of the material display assembly of FIG. 1 including the intermediate cutout 106 intersecting the upper edge 128 of the intermediate panel 104, the intermediate panel 304 of the material display assembly 300 includes an intermediate cutout 306 intersecting the second side edge 134 of the intermediate panel 304. This allows a display sheet to be inserted between the back panel 102 and the front panel 108 from the second side edge 134 of the intermediate panel 304 rather than the upper edge 128 of the intermediate panel 304. In other embodiments, the intermediate cutout 306 is positioned proximate the first side edge 132, i.e., closer to the first side edge 132 than to the second side edge 134 of the intermediate panel 304. Furthermore, in such embodiments, the intermediate cutout 306 may be oriented to intersect either the upper edge 128 of the intermediate panel 304 or the first side edge 132 of the intermediate panel 304.

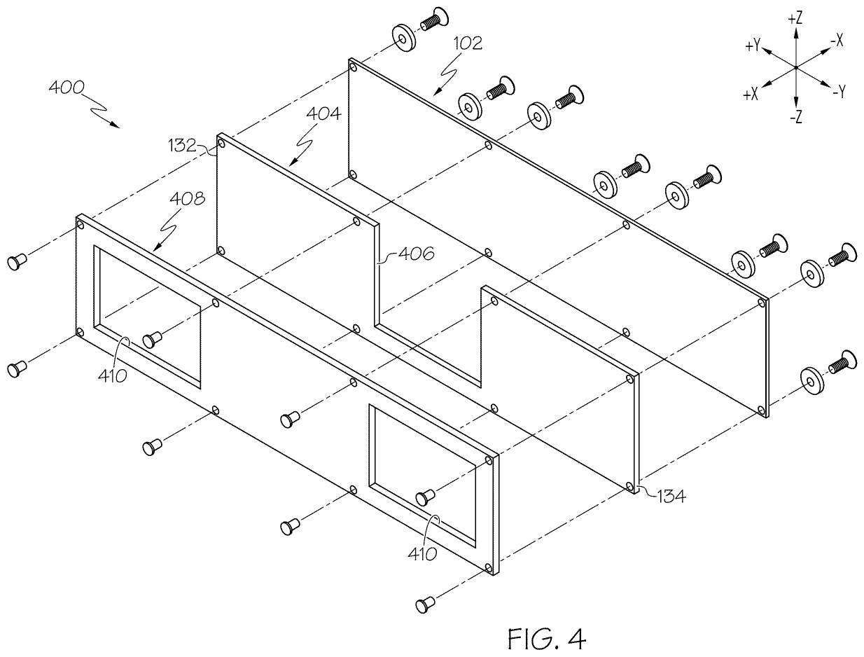

In other embodiments, as shown in FIG. 4, a material display assembly 400 is illustrated. It should be appreciated the material display assembly 400 is similar to the material display assembly 100 illustrated in FIG. 1. Therefore, like reference numbers will be used to refer to like parts. The material display assembly 400 includes the back panel 102, an intermediate panel 404, and a front panel 408. Contrary to the intermediate panel 104 of the material display assembly 100 of FIG. 1 including the intermediate cutout 106 being provided proximate the second side edge 134 of the intermediate panel 104, the intermediate panel 404 of the material display assembly 400 includes an intermediate cutout 406 positioned equidistantly between the first side edge 132 and the second side edge 134 of the intermediate panel 404. Additionally, contrary to the front panel 108 of the material display assembly 100 of FIG. 1 including the front cutouts 110 being provided proximate the first side edge 150 of the front panel 108, the front panel 408 includes a pair of front cutouts 410 positioned on opposite sides of the intermediate cutout 406. This allows one to view a display sheet provided within the intermediate cutout 406 through the front panel 408.

In other embodiments, it should be appreciated that the intermediate panel 104 may not be provided. In such embodiments, the back panel 102 and the front panel 108 may abut against one another and a display sheet may be provided directly between rather than being received in a cutout of an intermediate panel.

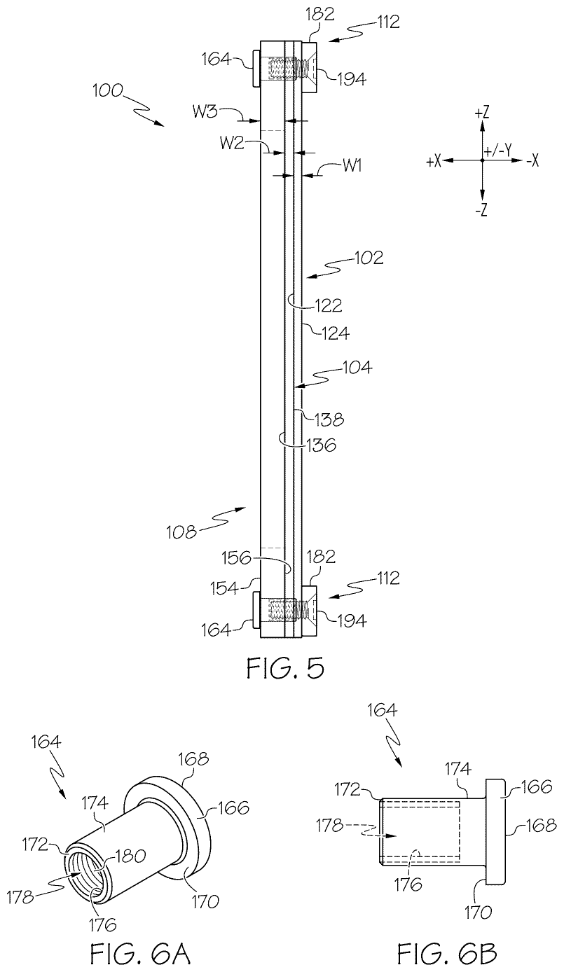

Referring now to FIG. 5, a side end view of the material display assembly 100 of FIG. 1 is illustrated. As shown, the front surface 122 of the back panel 102 abuts against the rear surface 138 of the intermediate panel 104, and the front surface 136 of the intermediate panel 104 abuts against the rear surface 156 of the front panel 108. Additionally, the fasteners 112 extend through the holes 126 formed in the back panel 102, the holes 144 formed in the intermediate panel 104, and the holes 162 formed in the front panel 108 to secure the back panel 102, the intermediate panel 104, and the front panel 108 to one another.

As described herein, the width W1 of the back panel 102, the width W2 of the intermediate panel 104, and the width W3 of the front panel 108 relative to one another may vary. However, as shown in FIG. 5, the width W3 of the front panel 108 is greater than each of the width W1 of the back panel 102 and the width W2 of the intermediate panel 104. Additionally, in the embodiment illustrated in FIG. 5, the width W1 of the back panel 102 is equal to the width W2 of the intermediate panel 104.

As described herein, the width W1 of the back panel 102, the width W2 of the intermediate panel 104, and the width W3 of the front panel 108 relative to one another may vary. However, as shown in FIG. 5, the width W3 of the front panel 108 is greater than each of the width W1 of the back panel 102 and the width W2 of the intermediate panel 104. Additionally, in the embodiment illustrated in FIG. 5, the width W1 of the back panel 102 is equal to the width W2 of the intermediate panel 104.

Now, referring to FIGS. 6A-8B, individual components of each of the fasteners 112 are illustrated. Specifically, as shown in FIGS. 6A and 6B, a screw post 164 is illustrated. The screw post 164 includes a head 166 having a front surface 168 and a rear surface 170 opposite the front surface 168, and a shaft 172 extending from the rear surface 170. The shaft 172 includes an outer surface 174 and an inner surface 176 opposite the outer surface 174. The inner surface 176 defines a screw channel 178 and includes inner threads 180 provided along a length of the screw channel 178.

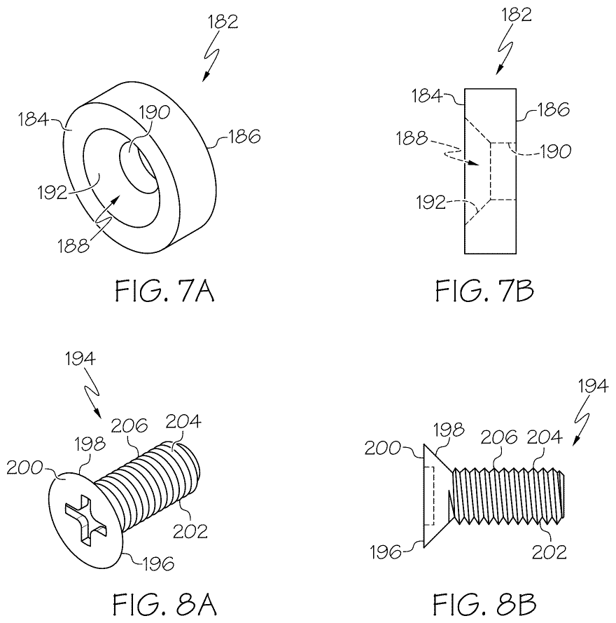

As shown in FIGS. 7A and 7B, a washer 182 of the fastener 112 is illustrated. The washer 182 has a front surface 184 and a rear surface 186 opposite the front surface 184. In embodiments, the washer 182 is formed from a magnetic material. In embodiments, the rear surface 186 of the washer 182 is formed from a magnetic material rather than forming the entire washer 182 from a magnetic material. A washer channel 188 is formed to extend through the washer 182. In embodiments, the washer channel 188 has a constant portion 190 extending from the front surface 184, and a conical portion 192 extending between the constant portion 190 and the rear surface 186.

As shown in FIGS. 8A and 8B, a screw 194 of the fastener 112 is illustrated. The screw 194 includes a head 196 having a front surface 198 and a rear surface 200 opposite the front surface 198, and a shaft 202 extending from the front surface 198. In embodiments, the front surface 198 of the head 196 is conical and corresponds to a shape of the conical portion 192 of the washer channel 188 of the washer 182 (FIG. 7A). The shaft 202 includes an outer surface 204 having outer threads 206 provided along a length of the outer surface 204.

Referring now to the individual components illustrated in FIGS. 6A-8B, and as shown in FIG. 5 in an assembled state, in use, the shaft 172 of each screw post 164 of the plurality of fasteners 112 is inserted through at least the holes 162 formed in the front panel 108. In embodiments, the shaft 172 of the screw post 164 is long enough such that the shaft 172 may also extend through the holes 144 formed in the intermediate panel 104 and, in some embodiments, the holes 126 formed in the back panel 102. In doing so, the rear surface 170 of the head 166 of the screw post 164 abuts against the front surface 154 of the front panel 108. In embodiments, the front surface 168 of the head 166 of the screw post 164 is smooth to provide for a clean aesthetic as viewed from the front surface 154 of the front panel 108.

Thereafter, the shaft 202 of the screw 194 is inserted through the washer channel 188. As noted above, in embodiments, the washer channel 188 includes the conical portion 192 that mates with the front surface 198 of the head 196 of the screw 194 also having a conical shape corresponding to the conical portion 192 of the washer channel 188. Additionally, the shaft 202 of the screw 194 extends through the constant portion 190 of the washer channel 188.

With the screw post 164 extended through the front panel 108 and the screw 194 extended through the washer 182, the screw 194 may be inserted through the holes 126 formed in the back panel 102 and the holes 144 formed in the intermediate panel 104. In doing so, the shaft 202 of the screw 194 is inserted into the screw channel 178 of the screw post 164 such that the outer threads 206 of the screw 194 engage the inner threads 180 of the screw post 164, and the front surface 184 of the washer 182 abuts against the rear surface 124 of the back panel 102.

As noted above, the rear surface 186 of the washer 182 is formed from a magnetic material. Accordingly, with the fasteners 112 assembled and extending through each of the holes 126, 144, 162 of the material display assembly 100, the material display assembly 100 may be positioned against a metal support surface such that the washer 182 of each of the fasteners 112 magnetically secures the material display assembly 100 to the metal support surface.

Additionally, as noted above, a display sheet may be inserted into the intermediate cutout 106 formed in the intermediate panel 104 between the back panel 102 and the front panel 108. Moreover, material samples may be positioned within the front cutouts 110 formed in the front panel 108 and secured therein using double sided tape or the like. Accordingly, the display sheet may present information, for example, pricing information, relevant to the material samples within the front cutouts 110. The display sheet can be switched out for different display sheets as desired by removing the display sheet from the intermediate cutout 106 without having to remove the back panel 102 and/or the front panel 108 from the intermediate panel 104. For example, the entire material display assembly 100 may be removed from metal support surface to which it is magnetically attached and turned upside down such that the display sheet falls out of the intermediate cutout 106. Similarly, the material samples may be switched out for different material samples as desired.

From the above, it is to be appreciated that defined herein is a material display assembly for displaying product and/or material information on a display sheet. The material display assembly includes at least a back panel and a front panel having one or more front cutouts in which a material sample may be displayed. The display sheet including product information relevant to the material samples may be positioned between the back panel and the front panel. As discussed herein, the display sheet may be positioned within an intermediate cutout formed within an intermediate panel positioned between the back panel and the front panel.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A material display assembly comprising:
a back panel;
an intermediate panel, an intermediate cutout formed in the intermediate panel intersecting an edge of the intermediate panel and defining an intermediate cutout region, the intermediate panel defining a material backing region adjacent the intermediate cutout region;
a front panel, a front cutout formed in the front panel and defining a front cutout region overlapping the material backing region of the intermediate panel, the front panel defining a display region adjacent the front cutout and overlapping the intermediate cutout region, the display region being transparent; and
one or more fasteners securing the intermediate panel to the back panel and the front panel.

2. The material display assembly of claim 1, wherein the intermediate cutout formed in the intermediate panel and the front cutout formed in the front panel are offset from one another.

3. The material display assembly of claim 1, wherein the front cutout comprises a pair of front cutouts spaced apart from one another and arranged along a length of the front panel.

4. The material display assembly of claim 3, wherein each front cutout of the pair of front cutouts have an equal length and an equal height.

5. The material display assembly of claim 1, wherein the intermediate cutout has a length equal to a length of the front cutout.

6. The material display assembly of claim 1, wherein the intermediate cutout has a height equal to a sum of a height of the front cutout and a distance between an upper edge of the front cutout and an upper edge of the front panel.

7. The material display assembly of claim 3, wherein the intermediate cutout is spaced apart from a lower edge of the intermediate panel by a first distance, and the pair of front cutouts are spaced apart from a lower edge of the front panel by a second distance equal to the first distance.

8. The material display assembly of claim 1, wherein the back panel has a length equal to a length of the intermediate panel and a length of the front panel.

9. The material display assembly of claim 1, wherein the back panel, the intermediate panel, and the front panel are formed from acrylic.

10. The material display assembly of claim 1, wherein the one or more fasteners include a plurality of fasteners provided at and extending through corners of the back panel, the intermediate panel, and the front panel.

11. The material display assembly of claim 10, wherein each fastener of the plurality of fasteners include a screw, a washer, and a screw post, the screw extending through the washer and into the screw post.

12. The material display assembly of claim 11, wherein the screw includes outer threads that engage inner threads of the screw post.

13. The material display assembly of claim 11, wherein the washer is magnetic.

14. The material display assembly of claim 11, wherein the washer includes a conical portion, and wherein the screw includes a head having a conical portion that mates with the conical portion of the washer when the screw engages the washer.

15. A material display assembly comprising:
a back panel;
a front panel, a pair of front cutouts formed in the front panel and spaced apart from one another and defining a front cutout region, the front panel defining a display region adjacent the front cutout region, the display region being transparent; and
one or more fasteners securing the back panel to the front panel.

16. The material display assembly of claim 15, wherein each front cutout of the pair of front cutouts have an equal length and an equal height.

17. The material display assembly of claim 15, wherein the back panel and the front panel are formed from acrylic.

18. The material display assembly of claim 15, wherein:
the one or more fasteners include a plurality of fasteners provided at and extending through corners of the back panel and the front panel; and
each fastener of the plurality of fasteners include a screw, a washer, and a screw post, the screw extending through the washer and into the screw post.

19. The material display assembly of claim 18, wherein:
the screw includes outer threads that engage inner threads of the screw post; and
the washer includes a conical portion, and wherein the screw includes a head having a convex portion that mates with the conical portion of the washer when the screw engages the washer.

20. The material display assembly of claim 18, wherein the washer is magnetic.
